(19) United States
(12) Patent Application Publication
(10) Pub. No.: US 2026/0018363 A1
(43) Pub. Date: Jan. 15, 2026

(54) X-RAY TUBE

(71) Applicant: CANON ELECTRON TUBES & DEVICES CO., LTD., Otawara-shi (JP)

(72) Inventor: Junki SONE, Nasushiobara (JP)

(73) Assignee: CANON ELECTRON TUBES & DEVICES CO., LTD., Otawara-shi (JP)

(21) Appl. No.: 19/257,757

(22) Filed: Jul. 2, 2025

(30) Foreign Application Priority Data
Jul. 12, 2024 (JP) 2024-112654

(51) Int. Cl. H01J 35/06; H01J 35/14

(52) U.S. Cl. CPC H01J 35/064; H01J 35/14; H01J 2235/18

(57) ABSTRACT

An X-ray tube includes an envelope, a plate-shaped output window located at an end of the envelope, a target facing the output window inside the envelope, a tubular focusing electrode surrounding the target inside the envelope, and a filament surrounding the focusing electrode inside the envelope. A first line is defined to pass through a center of a surface of the output window at the target side and to be tangent to an end of the focusing electrode at the output window side; and a center of the filament is positioned at the same side of the first line as the focusing electrode.

### CROSS-REFERENCE TO RELATED APPLICATIONS

This application is based upon and claims the benefit of priority from the Japanese Patent Application No. 2024-112654, filed on Jul. 12, 2024; the entire contents of which are incorporated herein by reference.

### FIELD

Embodiments described herein relate generally to an X-ray tube.

### BACKGROUND

A fixed-anode X-ray tube is one type of X-ray tube. Such an X-ray tube includes, for example, an envelope, and an output window located at one end of the envelope. An anode structure that faces the output window, a cathode structure located at the vicinity of the end of the anode structure at the output window side, and a focusing electrode located between the anode structure and the cathode structure also are located inside the envelope.

In such an X-ray tube, thermions are generated in the filament located at the cathode structure when a negative voltage is applied to the cathode structure. The thermions that are generated are accelerated by the potential difference between the cathode structure and the anode structure, to which a positive voltage is applied; the trajectory of the thermions is bent by an electric field generated by the envelope and the focusing electrode; and the thermions strike the target located at the anode structure. The X-rays that are generated by the thermions striking the target are irradiated outside the X-ray tube via the output window.

Here, when thermions are generated in the filament, metal atoms (e.g., tungsten atoms) included in the filament evaporate and desorb from the filament. In such a case, some of the metal atoms desorbed from the filament may diffuse inside the envelope and adhere to the output window. If the amount of metal atoms adhered to the output window becomes high, there is a risk that the transmittance of X-rays may be reduced, the characteristic X-ray intensity may be reduced, and impure X-rays may be unintentionally generated by the adhered metal atoms being excited by X-rays.

It is therefore desirable to develop an X-ray tube in which the adhesion to the output window of metal atoms desorbed from the filament can be suppressed.

### BRIEF DESCRIPTION OF THE DRAWINGS

FIG. 1 is a schematic partial cross-sectional view illustrating an X-ray tube according to an embodiment;

FIG. 2 is a schematic cross-sectional view illustrating a positional relationship of an output window, a focusing electrode, and a filament according to a comparative example;

FIG. 3 is a schematic view illustrating an adhesion state of metal atoms in the case of the positional relationship shown in FIG. 2;

FIG. 4 is a schematic cross-sectional view illustrating a positional relationship of an output window, a focusing electrode, and a filament according to the embodiment;

FIG. 5 is a schematic view illustrating an adhesion state of metal atoms in the case of the positional relationship shown in FIG. 4;

FIG. 6 is a schematic cross-sectional view illustrating a positional relationship of an output window, a focusing electrode, and a filament according to another embodiment;

FIG. 7 is a schematic view illustrating an adhesion state of metal atoms in the case of the positional relationship shown in FIG. 6;

FIG. 8 is a graph illustrating a relationship between the positional relationship between the output window, the focusing electrode, and the filament and the area ratio of the region to which metal atoms do not easily adhere; and

FIG. 9 is a graph illustrating a relationship between the usage time of the X-ray tube and the characteristic X-ray intensity.

### DETAILED DESCRIPTION

An X-ray tube according to an embodiment includes an envelope, a plate-shaped output window located at an end of the envelope, a target facing the output window inside the envelope, a tubular focusing electrode surrounding the target inside the envelope, and a filament surrounding the focusing electrode inside the envelope. A first line is defined to pass through a center of a surface of the output window at the target side and to be tangent to an end of the focusing electrode at the output window side; and a center of the filament is positioned at the same side of the first line as the focusing electrode.

Exemplary embodiments will now be described with reference to the drawings. Similar components in the drawings are marked with like reference numerals; and a detailed description is omitted as appropriate.

The X-ray tube 1 according to the embodiment can be used in, for example, a fluorescent X-ray analysis apparatus. However, applications of the X-ray tube 1 are not limited to a fluorescent X-ray analysis apparatus.

In the specification, a pressure state that is less than atmospheric pressure is referred to as a vacuum state.

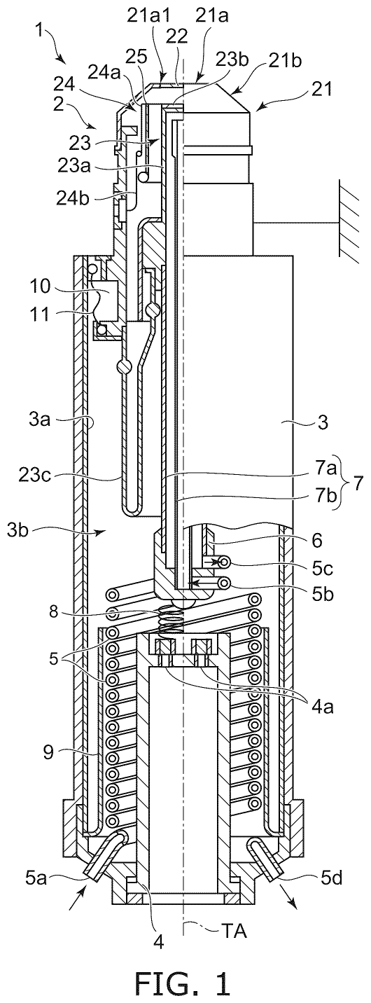

FIG. 1 is a schematic partial cross-sectional view illustrating the X-ray tube 1 according to the embodiment.

As shown in FIG. 1, the X-ray tube 1 includes, for example, an X-ray generator 2, a tube container 3, a high-voltage receptacle 4, a cooling pipe 5, a joint 6, a conduit pipe 7, a conductor spring 8, an insulating tube 9, an expansion chamber 10, and a bellows 11.

The installation direction of the X-ray tube 1 is not particularly limited. For example, the X-ray tube 1 can be installed so that a tube axis TA extends in the vertical direction, or can be installed so that the tube axis TA extends in a direction crossing the vertical direction. For example, the X-ray generator 2 side of the X-ray tube 1 can face downward in the direction of gravity, upward in the direction of gravity, or horizontally.

The tube container 3 houses the X-ray generator 2, the high-voltage receptacle 4, the cooling pipe 5, the joint 6, the conduit pipe 7, the conductor spring 8, the insulating tube 9, the expansion chamber 10, and the bellows 11 inside the tube container 3. The tube container 3 is, for example, substantially circular tubular. For example, the central axis of the tube container 3 can be substantially coaxial with the tube axis TA of the X-ray tube 1. For example, the tube container 3 is formed from a metal; and a lead plate 3a is located at the inner wall of the tube container 3. An internal space 3b of the tube container 3 is filled with an insulating oil. The internal space 3b is, for example, the space between the inner wall of the lead plate 3a and the outer surfaces of the X-ray generator 2 and the high-voltage receptacle 4, and is a space other than the expansion chamber 10.

For example, the high-voltage receptacle 4 is substantially circular tubular such that one end is open and the other end is sealed. A high-voltage cable is connected inside the high-voltage receptacle 4. The high-voltage receptacle 4 is located at the end of the tube container 3 at the side opposite to the X-ray generator 2 side, and is liquid-tight. A pair of connection terminals 4a is located at the closed end of the high-voltage receptacle 4. The connection terminals 4a each include a terminal and a bushing of an external power path inserted into the high-voltage receptacle 4.

The cooling pipe 5 is a conduit that carries a cooling liquid (e.g., purified water). The cooling pipe 5 is spiral and is located between the high-voltage receptacle 4 and the insulating tube 9. The cooling pipe 5 may not be spiral.

The cooling pipe 5 includes a cooling pipe 5b having a water supply port 5a to which a cooling liquid is supplied, and a cooling pipe 5c having a drain port 5d from which the cooling liquid is discharged. The water supply port 5a of the cooling pipe 5b is connected to a circulating cooling device or the like that is a supply source of the cooling liquid located outside the X-ray tube 1. The end of the cooling pipe 5b at the side opposite to the water supply port 5a side is connected to the joint 6. The drain port 5d of the cooling pipe 5c is connected to the circulating cooling device or the like. The end of the cooling pipe 5c at the side opposite to the drain port 5d side is connected to the joint 6.

The joint 6 is located at the central vicinity of the X-ray tube 1 and connects the cooling pipe 5 and the conduit pipe 7.

The conduit pipe 7 includes a substantially circular tubular outer pipe 7a, and a substantially circular tubular inner pipe 7b located inside the outer pipe 7a. For example, the conduit pipe 7 extends along the tube axis TA. The conduit pipe 7 is connected to the joint 6.

The outer pipe 7a is liquid-tightly connected to the joint 6 and a support part 23a of an anode structure 23 that will be described below.

The inner pipe 7b has a smaller outer diameter than the outer pipe 7a. The inner pipe 7b extends along the tube axis TA.

The conductor spring 8 is located between the joint 6 and connection terminals 4a. The conductor spring 8 electrically connects the joint 6 and the connection terminals 4a.

The insulating tube 9 is substantially circular tubular and is formed from an insulating material. For example, the insulating tube 9 has a structure configured to circulate an insulating oil. For example, one end of the insulating tube 9 is fixed to the inner side of the tube container 3.

The expansion chamber 10 is a space isolated from the internal space 3b of the tube container 3 by the bellows 11. The expansion chamber 10 is provided to absorb the volume change when the insulating oil filled into the internal space 3b of the tube container 3 expands or contracts. The expansion chamber 10 communicates with the outside of the X-ray tube 1.

The bellows 11 is located inside the tube container 3 and isolates the internal space 3b of the tube container 3 and the expansion chamber 10. The bellows 11 can be formed from an elastic material such as rubber, etc. An expandable/contractible member that is expandable and contractible can be used as the bellows 11. For example, the bellows 11 can be a so-called rubber bellows (rubber membrane). As long as the bellows 11 is an expandable/contractible member that is expandable and contractible, the expansion chamber 10, which communicates with the outside of the X-ray tube 1 via the bellows 11, can contract or expand as the insulating oil expands or contracts. In other words, the bellows 11 is provided so that the expansion chamber 10 can absorb the expansion or contraction of the insulating oil.

The X-ray generator 2 includes, for example, an envelope 21, an output window 22, the anode structure 23, a cathode structure 24, and a focusing electrode 25.

The envelope 21 is, for example, tubular. For example, the central axis of the envelope 21 can be substantially coaxial with the tube axis TA of the X-ray tube 1. One end of the envelope 21 (the end at the tube container 3 side) is open. Another end 21a of the envelope 21 is a substantially flat surface. A hole 21a1 is formed in the central region of the end 21a of the envelope 21.

The side part of the envelope 21 has an inclined part 21b at the end 21a side. The inclined part 21b is inclined to approach the tube axis TA of the X-ray tube 1 toward the end 21a. For example, the inner diameter of the envelope 21 (the inner wall dimension in a direction crossing the tube axis TA) gradually decreases toward the tip. The electric field that is generated by the inclined part 21b and the focusing electrode 25 can control the trajectory of the thermions from a filament 24a toward a target 23b. For example, the region (the focal point) where the thermions are incident on the target 23b can be set to the appropriate size by changing the angle between the inner wall of the inclined part 21b and the tube axis TA of the X-ray tube 1. By setting the region (the focal point) where the thermions are incident on the target 23b to be the appropriate size, overheating and melting of the target 23b can be suppressed.

For example, the envelope 21 can be formed from a metal such as stainless steel, etc.

The output window 22 is discal, and is located at the end 21a of the envelope 21. The output window 22 makes the hole 21a1 of the end 21a of the envelope 21 airtight. For example, the perimeter edge of the output window 22 is bonded by brazing or the like at the vicinity of the perimeter edge of the hole 21a1. The output window 22 transmits the X-rays generated inside the envelope 21 while maintaining the vacuum state inside the envelope 21. Therefore, the output window 22 is formed from a material having low X-ray attenuation. For example, the output window 22 is formed from beryllium, etc. To reduce the X-ray attenuation, for example, the thickness of the output window 22 can be set to about several tens of μm to several 100 μm.

According to the application of the X-ray tube 1, there are cases where corrosive gases are present, or scattering of corrosive substances occur in the atmosphere in which the X-ray tube 1 is located. In such a case, the surface of the output window 22 at the side opposite to the target 23b side can be covered with a protective film. The protective film can include, for example, diamond-like carbon as a major material. For example, the protective film can be formed by forming a film to cover the output window 22 by using a film formation technique such as vapor deposition, etc. The thickness of the protective film can be, for example, about 0.5 μm to 1 μm.

The target 23b side of the anode structure 23 is located inside the envelope 21. The side of the anode structure 23 opposite to the target 23b side is located inside the tube container 3.

The anode structure 23 includes, for example, the support part 23a, the target 23b, and a sealing part 23c.

The support part 23a is substantially circular tubular, and extends along the tube axis TA of the X-ray tube 1. One end of the support part 23a is located inside the envelope 21 and faces the output window 22. The other end of the support part 23a is located inside the tube container 3 and is electrically connected to the high-voltage receptacle 4 via the joint 6, the conductor spring 8, and the connection terminals 4a. For example, the support part 23a is formed from a conductive material such as copper, etc.

When a high voltage is applied to the high-voltage receptacle 4 via the high-voltage cable electrically connected to the high-voltage receptacle 4, a high voltage (a tube voltage) is applied between the filament 24a and the target 23b that are electrically connected to the support part 23a.

For example, the target 23b is discal and is located inside the envelope 21. For example, the central axis of the target 23b can be substantially coaxial with the tube axis TA of the X-ray tube 1. The target 23b faces the output window 22. For example, the target 23b can be located at the end of the support part 23a facing the output window 22. The target 23b includes a material that generates X-rays when struck by thermions. The target 23b includes, for example, at least one of Rh (rhodium), W (tungsten), molybdenum (Mo), chrome (Cr), palladium (Pd), platinum (Pt), or copper (Cu).

The sealing part 23c is located inside the tube container 3. The sealing part 23c airtightly seals the end of the X-ray generator 2 at the side opposite to the envelope 21 side. In other words, the sealing part 23c is provided to maintain the vacuum state of the space inside the envelope 21. For example, the sealing part 23c can be formed from a glass material, a ceramic, etc.

The cathode structure 24 is located inside the envelope 21.

The cathode structure 24 includes, for example, the filament 24a and a support part 24b.

The filament 24a surrounds the focusing electrode 25 and the target 23b. The filament 24a is wire-shaped, and is substantially circular or substantially C-shaped when viewed along a direction along the tube axis TA of the X-ray tube 1. For example, the filament 24a can be formed from a wire including tungsten as a major component.

One end of the support part 24b is electrically connected with the filament 24a. The other end of the support part 24b is electrically connected to a cable or the like located outside the X-ray tube 1. For example, the filament 24a is electrically connected with an anode of a power supply located outside the X-ray tube 1 via the support part 24b, the cable, etc.

The focusing electrode 25 is, for example, substantially circular tubular. For example, the central axis of the focusing electrode 25 can be substantially coaxial with the tube axis TA of the X-ray tube 1. The focusing electrode 25 surrounds the target 23b. The focusing electrode 25 is located between the target 23b and the filament 24a when viewed along the direction along the tube axis TA of the X-ray tube 1. For example, the focusing electrode 25 can be formed from a conductive material such as iron (Fe), stainless steel, etc.

The focusing electrode 25 and the envelope 21 can be grounded. Or, the focusing electrode 25 and the envelope 21 can be electrically connected with a power supply located outside the X-ray tube 1. When the focusing electrode 25 and the envelope 21 are connected with the power supply, the voltage that is applied to the focusing electrode 25 and the envelope 21 can be higher than the voltage applied to the filament 24a and lower than the voltage applied to a support part 41.

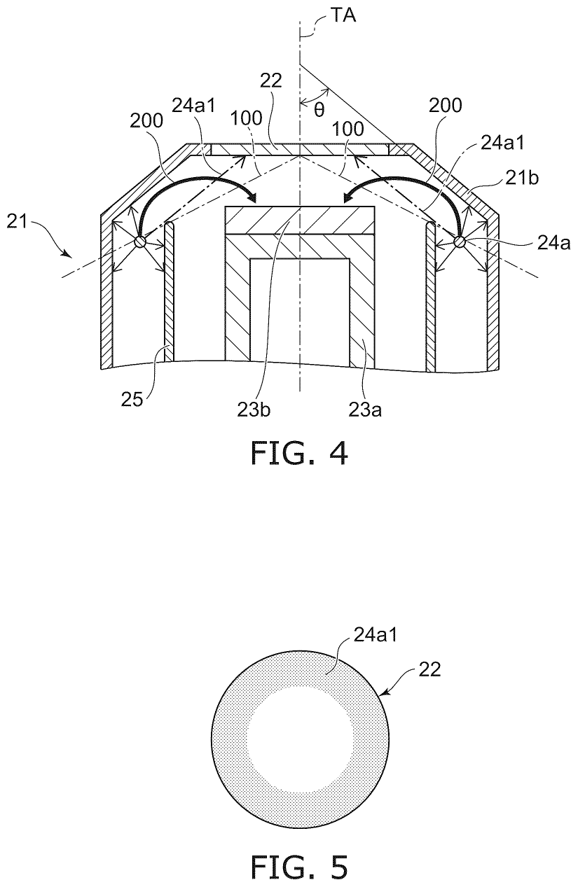

Here, when the power supply located outside the X-ray tube 1 applies a negative voltage to the filament 24a, the filament 24a is heated and generates thermions 200 as shown in FIGS. 4 and 6, which are described below.

The power supply that is located outside the X-ray tube 1 applies a positive voltage to the target 23b via the high-voltage cable, the high-voltage receptacle 4, and the support part 23a.

The thermions 200 that are generated are accelerated by the potential difference between the filament 24a and the target 23b to which the positive voltage is applied; the trajectory of the thermions 200 is bent by the electric field generated by the envelope 21 and the focusing electrode 25; and the thermions 200 strike the target 23b. X-rays are generated by the thermions 200 striking the target 23b. The X-rays that are generated are transmitted by the output window 22 and irradiated on, for example, the surface of a fluorescent X-ray analysis sample, etc.

Here, when the thermions 200 are generated in the filament 24a, the metal atoms (e.g., tungsten atoms) 24a1 included in the filament 24a evaporate and desorb from the filament 24a. The metal atoms 24a1 that desorb from the filament 24a are electrically neutral, and so the metal atoms 24a1 move linearly through the interior of the envelope 21 without being affected by the electric field generated inside the envelope 21. Therefore, there are cases where some of the metal atoms 24a1 desorbed from the filament 24a diffuse through the interior of the envelope 21 and adhere to the surface of the output window 22 at the target 23b side. In such a case, as the usage time of the X-ray tube 1 lengthens, the metal atoms 24a1 may continuously adhere, and the amounts of the metal atoms 24a1 adhered to the output window 22 may increase.

X-rays are not easily transmitted by the metal atoms 24a1 such as tungsten atoms, etc., and so there is a risk that the X-ray transmittance may be reduced and the characteristic X-ray intensity may be reduced if the amount of the metal atoms 24a1 adhered to the output window 22 increases. Also, there is a risk that the metal atoms 24a1 that are adhered to the output window 22 may be excited by the X-rays to unintentionally generate impure X-rays; and the function as the X-ray tube 1 may be degraded.

As a result of investigations, the inventor found that the adhesion of the metal atoms 24a1 to the output window 22 can be suppressed by appropriately setting the positional relationship between the output window 22, the focusing electrode 25, and the filament 24a.

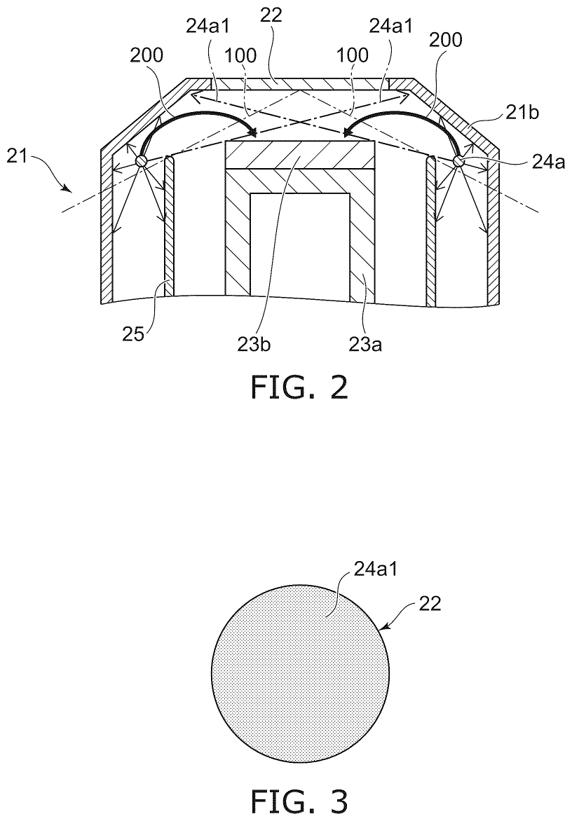

FIG. 2 is a schematic cross-sectional view illustrating a positional relationship of the output window 22, the focusing electrode 25, and the filament 24a according to a comparative example.

FIG. 3 is a schematic view illustrating the adhesion state of the metal atoms 24a1 in the case of the positional relationship shown in FIG. 2.

In FIG. 2, a line 100 (corresponding to an example of the first line) passes through the center of the surface of the output window 22 at the target 23b side and is tangent to the end of the focusing electrode 25 at the output window 22 side. In the case of the positional relationship of FIG. 2, the filament 24a is positioned at the opposite side of the line 100 as the focusing electrode 25. In such a case, as shown in FIG. 2, the metal atoms 24a1 that desorb from the filament 24a and move linearly reach the entire region of the surface of the output window 22 at the target 23b side directly.

Therefore, as shown in FIG. 3, the metal atoms 24a1 adhere to the entire region of the surface of the output window 22 at the target 23b side.

For example, as the usage time of the X-ray tube 1 lengthens, the entire region of the surface of the output window 22 at the target 23b side is covered with the metal atoms 24a1; and the X-ray transmittance is reduced. The characteristic X-ray intensity may be reduced when the X-ray transmittance is reduced. Also, there is a risk that the metal atoms 24a1 that are adhered to the output window 22 may be excited by the X-rays to unintentionally generate impure X-rays; and the function as the X-ray tube 1 may be degraded.

FIG. 4 is a schematic cross-sectional view illustrating the positional relationship of the output window 22, the focusing electrode 25, and the filament 24a according to the embodiment.

FIG. 5 is a schematic view illustrating the adhesion state of the metal atoms 24a1 in the case of the positional relationship shown in FIG. 4.

In the case of the positional relationship of FIG. 4, the center of the filament 24a is positioned at the same side of the line 100 as the focusing electrode 25. In such a case, as shown in FIG. 4, the metal atoms 24a1 that desorb from the filament 24a and move linearly are shielded by the focusing electrode 25 and do not easily reach the central region of the surface of the output window 22 at the target 23b side directly.

Therefore, as shown in FIG. 5, the metal atoms 24a1 adhere to the perimeter edge region of the surface of the output window 22 at the target 23b side, but do not easily adhere to the central region of the surface of the output window 22 at the target 23b side.

In such a case, as shown in FIG. 4, if the center of the filament 24a is positioned at the same side of the line 100 as the focusing electrode 25, and the line 100 is tangent to the filament 24a, the ratio of the area of the central region, to which the metal atoms 24a1 do not easily adhere, to the area of the entire region of the output window 22 can be 40% or more.

Here, the metal atoms 24a1 adhere to the perimeter edge region of the surface of the output window 22 at the target 23b side, and so the reduction of the characteristic X-ray intensity and the generation of impure X-rays described above may occur. However, in terms of the function of the X-ray tube 1, the characteristic X-ray intensity and the generation of impure X-rays in the central region of the output window 22 are important, and so it is common that the reduction of the characteristic X-ray intensity and the generation of impure X-rays in the perimeter edge region of the output window 22 would have little effect on the practical functions.

For example, when the metal atoms 24a1 were adhered to the entire region of the output window 22, the reduction of the characteristic X-ray intensity was about 5% on an annual basis (when used for 8,760 hours). In contrast, when the ratio of the area of the central region, to which the metal atoms 24a1 did not easily adhere, to the area of the entire region of the output window 22 was about 40%, the reduction of the characteristic X-ray intensity was not more than about 2% on an annual basis (when used for 8,760 hours). In other words, the reduction of the characteristic X-ray intensity could be within a practically acceptable level.

FIG. 6 is a schematic cross-sectional view illustrating the positional relationship of the output window 22, the focusing electrode 25, and the filament 24a according to another embodiment.

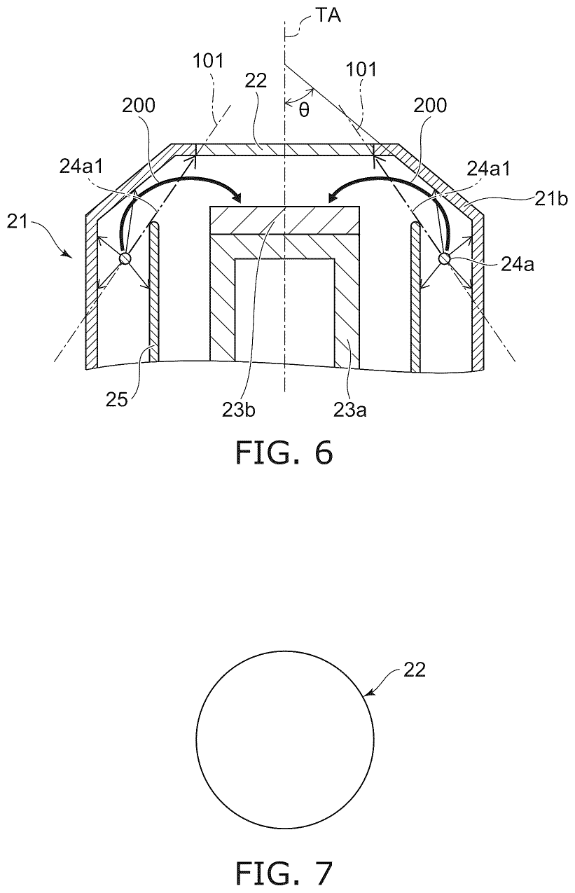

FIG. 7 is a schematic view illustrating the adhesion state of the metal atoms 24a1 in the case of the positional relationship shown in FIG. 6.

In FIG. 6, a line 101 (corresponding to an example of a second line) passes through the perimeter edge of the surface of the output window 22 at the target 23b side and is tangent to the end of the focusing electrode 25 at the output window 22 side. In the case of the positional relationship of FIG. 6, the center of the filament 24a overlaps the line 101. In such a case, as shown in FIG. 6, the metal atoms 24a1 that desorb from the filament 24a and move linearly are shielded by the focusing electrode 25 and do not easily reach the entire region of the surface of the output window 22 at the target 23b side directly.

Therefore, as shown in FIG. 7, the metal atoms 24a1 do not easily adhere to the entire region of the surface of the output window 22 at the target 23b side. In such a case, when the ratio of the area of the central region, to which the metal atoms 24a1 do not easily adhere, to the area of the entire region of the output window 22 was not less than 90%, the reduction of the characteristic X-ray intensity was not more than about 1% on an annual basis (when used for 8,760 hours). In other words, the reduction of the characteristic X-ray intensity and the generation of impure X-rays could be substantially eliminated.

The center of the filament 24a may be positioned at the same side of the line 101 as the focusing electrode 25. Thus, the metal atoms 24a1 that desorb from the filament 24a and move linearly are even easier for the focusing electrode 25 to shield. Therefore, the adhesion of the metal atoms 24a1 to the entire region of the surface of the output window 22 at the target 23b side can be more reliably suppressed.

Here, as the distances between the center of the filament 24a and the lines 100 and 101 lengthen, the area of the metal atoms 24a1 shielded by the focusing electrode 25 increases, and so the region to which the metal atoms 24a1 do not easily adhere can be increased. However, as the distances between the center of the filament 24a and the lines 100 and 101 lengthen, there is a risk that the region (the focal point) where the thermions 200 are incident on the target 23b may become too small, and the target 23b may overheat and melt.

As described above, for example, the trajectory of the thermions 200 from the filament 24a toward the target 23b can be controlled by the angle between the inner wall of the inclined part 21b and the tube axis TA of the X-ray tube 1.

For example, as shown in FIGS. 4 and 6, it is sufficient to increase an angle θ between the inner wall of the inclined part 21b and the tube axis TA of the X-ray tube 1 as the distances between the center of the filament 24a and the lines 100 and 101 are increased. In other words, the overheating and melting of the target 23b can be suppressed by appropriately setting the angle θ according to the distances between the center of the filament 24a and the lines 100 and 101.

The appropriate range of the angle θ can be appropriately determined by performing experiments and/or simulations according to the distances between the center of the filament 24a and the lines 100 and 101.

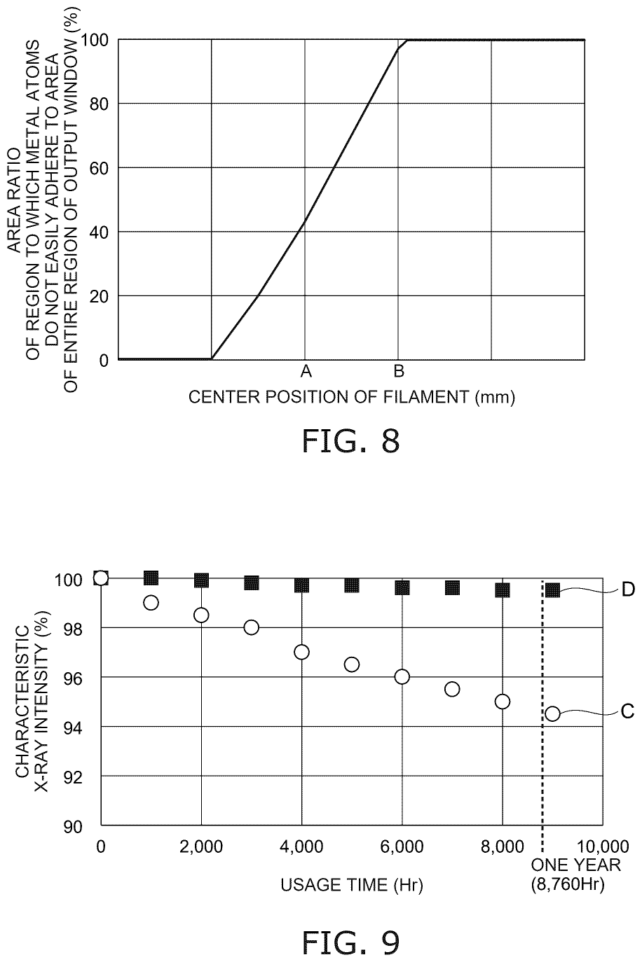

FIG. 8 is a graph illustrating the relationship between the positional relationship between the output window 22, the focusing electrode 25, and the filament 24a and the area ratio of the region to which the metal atoms 24a1 do not easily adhere.

At the horizontal axis of FIG. 8, A illustrates the positional relationship of FIG. 4. B illustrates the positional relationship of FIG. 6.

As can be seen for A of FIG. 8, by using the positional relationship of FIG. 4, the ratio of the area of the central region, to which the metal atoms 24a1 do not easily adhere, to the area of the entire region of the output window 22 was not less than 40%. Therefore, the reduction of the characteristic X-ray intensity could be within a practically acceptable level.

As can be seen for B in FIG. 8, by using the positional relationship of FIG. 6, the ratio of the area of the central region, to which the metal atoms 24a1 do not easily adhere, to the area of the entire region of the output window 22 was not less than 90%. Therefore, the reduction of the characteristic X-ray intensity and the generation of impure X-rays were substantially eliminated.

FIG. 9 is a graph illustrating the relationship between the usage time of the X-ray tube 1 and the characteristic X-ray intensity.

8,760 hours on the horizontal axis of FIG. 9 corresponds to when the X-ray tube 1 was used continuously for one year.

In FIG. 9, C illustrates the positional relationship according to the comparative example shown in FIG. 2.

In FIG. 9, D illustrates the positional relationship according to the embodiment shown in FIG. 6.

As can be seen in FIG. 9, the characteristic X-ray intensity is markedly reduced as the usage time lengthens for the positional relationship according to the comparative example. The characteristic X-ray intensity after 8,760 hours had elapsed was about 5% less than the characteristic X-ray intensity when the usage time was 0 hours.

In contrast, when the positional relationship according to the embodiment was used, the characteristic X-ray intensity was not markedly decreased even for a long usage time. For example, the reduction of the characteristic X-ray intensity after 8,760 hours had elapsed was within 1% of the characteristic X-ray intensity when the usage time was 0 hours.

In other words, by using the X-ray tube 1 according to the embodiment, the reduction of the characteristic X-ray intensity when used for a long period of time can be suppressed. It is therefore unnecessary to correct the characteristic X-ray intensity even when used for a long period of time. Even when it is necessary to correct the characteristic X-ray intensity, the frequency of the correction can be reduced. Therefore, the X-ray tube 1 that has a long life and is resistant to performance degradation can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments herein may be made without departing from the spirit of the inventions. The accompanying claims and their equivalents are intended to cover such forms or modifications as would fall within the scope and spirit of the inventions. Appropriate design modifications of the embodiments above made by one skilled in the art are within the scope of the inventions to the extent that the features of the inventions are included.

For example, the shapes, dimensions, material properties, arrangements, etc., of the components included in the X-ray tube 1 are not limited to those illustrated, and can be modified as appropriate.

The components included in the embodiments above can be combined within the limits of technical feasibility, and are within the scope of the inventions to the extent that the features of the inventions are included.

What is claimed is:

1. An X-ray tube comprising:
an envelope;
an output window located at an end of the envelope, the output window being plate-shaped;
a target located inside the envelope, the target facing the output window;
a focusing electrode located inside the envelope, the focusing electrode being tubular and surrounding the target; and
a filament located inside the envelope, the filament surrounding the focusing electrode,
a first line being defined to pass through a center of a surface of the output window at the target side and to be tangent to an end of the focusing electrode at the output window side,
a center of the filament being positioned at a same side of the first line as the focusing electrode.

2. The X-ray tube according to claim 1, wherein
the first line is tangent to the filament.

3. The X-ray tube according to claim 1, wherein
a second line is defined to pass through a perimeter edge of the surface of the output window at the target side and to be tangent to the end of the focusing electrode at the output window side, and
the center of the filament overlaps the second line or is positioned at a same side of the second line as the focusing electrode.

4. The X-ray tube according to claim 1, wherein
the filament is wire-shaped, and
the filament is substantially circular or substantially C-shaped when viewed along a direction along a tube axis of the X-ray tube.
